(19) United States
(12) Patent Application Publication
(10) Pub. No.: US 2010/0008207 A1
(43) Pub. Date: Jan. 14, 2010

(54) Method and Apparatus for Optical Power Transfer Control

(75) Inventors: Donald J. Denis, Barrie (CA); William Conrad Stenton, Midland (CA)

Correspondence Address: HAYNES AND BOONE, LLP;IP Section, 2323 Victory Avenue, Suite 700, Dallas, TX, 75219, US

(73) Assignee: RAYTHEON COMPANY, Waltham, MA (US)

(21) Appl. No.: 12/169,102

(22) Filed: Jul. 8, 2008

(51) Int. Cl. G11B 7/00

(52) U.S. Cl. 369/109.01

(57) ABSTRACT

A method and apparatus involve: supporting an optical part for movement in relation to a first path of travel of radiation; moving the part successively to first and second positions in which radiation arriving along the first path of travel passes respectively through first and second sections of the part that provide respective different levels of refraction, the first and second sections causing radiation to thereafter travel along respective second and third paths of travel; and receiving at an output first and second portions of radiation respectively propagating along the second and third paths of travel, the first and second portions containing different amounts of optical energy.

### FIELD OF THE INVENTION

This invention relates in general to optical systems and, more particularly, to techniques for optical power transfer control in optical systems.

### BACKGROUND

In optical systems, there is often a need to regulate optical power. In one existing approach, a beam of radiation is expanded, collimated, and then routed through a variable density filter. The radiation exiting the filter is then collected and refocused to the output. The filter can be moved with respect to the beam. The position of the filter in relation to the beam determines the power transfer from the input to the output, which is a function of the density of the portion of the filter through which the beam is currently passing.

Although systems of this type has been generally adequate for their intended purposes, they have not be satisfactory in all respects. For example, a variable density filter is a relatively expensive component. In addition, a variable density filter will absorb some portion of the energy of the beam passing through it. The amount of energy absorbed depends on the density of the portion of the filter through which the beam is currently passing.

### BRIEF DESCRIPTION OF THE DRAWINGS

A better understanding of the present invention will be realized from the detailed description that follows, taken in conjunction with the accompanying drawing, in which:

FIG. 1 is diagrammatic fragmentary view of an optical apparatus that provides optical power transfer control, and that embodies aspects of the invention.

FIG. 2 is a diagrammatic side view of selected structure from the embodiment of FIG. 1, including a disk, a motor shaft and an axis of rotation.

FIG. 3 is a diagrammatic fragmentary view of the apparatus of FIG. 1, but showing the disk in a different operational position.

FIG. 4 is a diagrammatic view showing the end of an optical output fiber depicted in FIG. 1, and showing how a beam of radiation moves in relation to the output fiber as the disk is rotated, the plane of FIG. 4 being coincident with the plane of an end surface of the output fiber.

FIG. 5 is a diagram showing the energy distribution that is present within a beam of radiation at the plane of the end surface of the output fiber.

FIG. 6 is diagrammatic fragmentary view of an optical apparatus that is an alternative embodiment of the optical apparatus of FIG. 1, that provides optical power transfer control, and that embodies aspects of the invention.

FIG. 7 is a diagrammatic fragmentary view of the apparatus of FIG. 6, but showing a different operational position.

### DETAILED DESCRIPTION

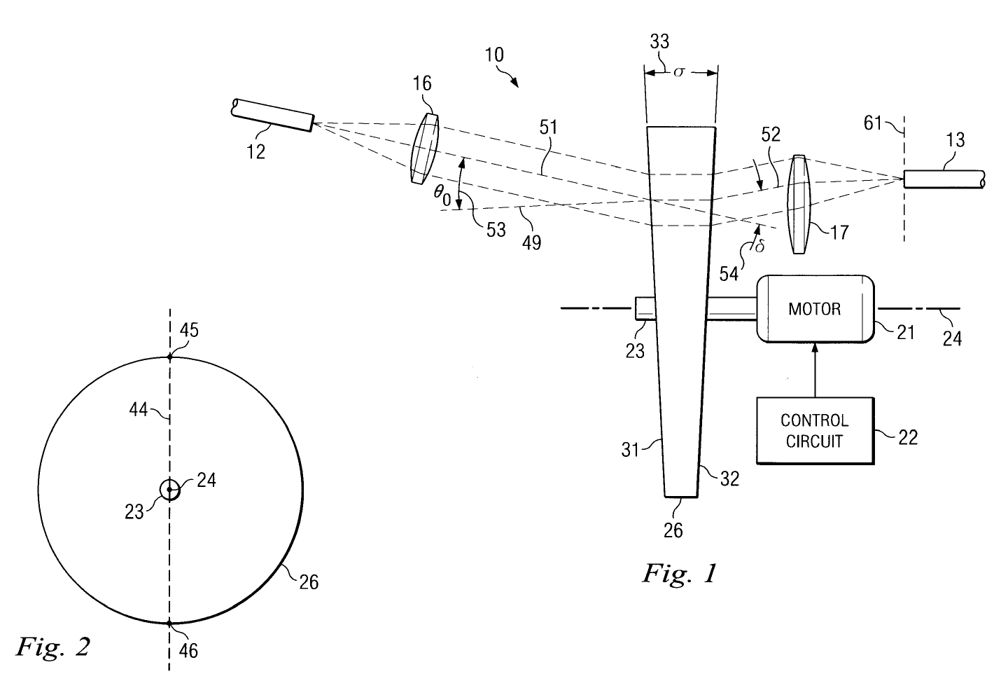

FIG. 1 is diagrammatic fragmentary view of an optical apparatus 10 that provides optical power transfer control, and that embodies aspects of the invention. FIG. 1 is not completely to scale, for example in that some angles and distances have been exaggerated for clarity. The apparatus 10 includes two optical fibers 12 and 13 of a known type. The optical fiber 12 is an input fiber, and the optical fiber 13 is an output fiber. The apparatus 10 also includes two optical lenses 16 and 17 of a known type. The lens 16 is a collimating lens, and the lens 17 is an imaging lens. Further, the apparatus 10 includes a motor 21 having a shaft 23 that can rotate about an axis of rotation 24. The motor 21 is controlled by a control circuit 22. In the embodiment of FIG. 1, the motor 21 is a stepper motor, but it could alternatively be any other suitable type of motor. Although the embodiment of FIG. 1 uses the motor 21 to rotate the shaft 23, it would alternatively be possible to rotate the shaft 23 manually, or using any other suitable structure.

A circular optical disk 26 is fixedly mounted on the shaft 23 of the motor 21, in a manner so that the axis of the circular disk 26 is coincident with the rotational axis 24 of the motor shaft 23. FIG. 2 is a diagrammatic side view of the disk 26, the motor shaft 23 and the axis 24. The disk 26 has two planar side surfaces 31 and 32 on opposite sides thereof. The surfaces 31 and 32 form an angle 33 (σ) with respect to each other. Thus, in the side view of FIG. 1, the disk 26 has a wedged-shaped appearance.

In the rotational position of the disk 26 that is shown in FIGS. 1 and 2, the thickest portion of the disk is at the very top (at 45 in FIG. 2), and the thinnest portion is at the very bottom (at 46 in FIG. 2). In FIG. 2, reference numeral 44 designates an imaginary line that is perpendicular to and intersects the axis of rotation 24, and that passes through the thickest portion 45 and the thinnest portion 46 of the disk. As the disk 26 rotates, the imaginary line 44 rotates with the disk.

Incoming radiation exits the input fiber 12 and then travels to the collimating lens 16. The lens 16 collimates the radiation from the input fiber 12. The collimated radiation then travels from the lens 16 along a path of travel 51 to the disk 26. Radiation propagating along the path of travel 51 impinges on the side surface 31 of the disk 26 at an initial angle of incidence 53 (θ₀) in relation to a line 49 perpendicular to the side surface 31. This radiation enters the disk 26 through the side surface 31, and then exits through the side surface 32. As this radiation is passing through the disk 26, it is refracted or redirected in a manner so that, after exiting the disk, it travels along a path of travel 52 that forms an angle 54 (δ) with respect to the path of travel 51. Using Snell's law equations (applied in a two-dimensional sense), the relationship between the angles 33 (σ) and 54 (δ) is given by equation (1) below.

$$δ = {sin}^{- 1} ( \frac{{n}_{disk}}{{n}_{air}} * sin \{ {sin}^{- 1} [ \frac{{n}_{air}}{{n}_{disk}} * sin ( {θ}_{0} ) ] - σ \} ) - {sin}^{- 1} ( \frac{{n}_{disk}}{{n}_{air}} * sin \{ {sin}^{- 1} [ \frac{{n}_{air}}{{n}_{disk}} * sin ( {θ}_{0} ) ] \} ) \qquad ( 1 )$$

where nₐᵢᵣ is the index of refraction of air, and n_{disk} is the index of refraction of the disk 26. For any rotational position of the disk 26, equation (1) gives the deviation angle 54 (δ) as measured within a not-illustrated imaginary plane that contains line 51 and is parallel to line 44. Within this imaginary plane, the deviation from line 51 to line 52 will always occur in a direction toward the thickest portion of the disk (as viewed within that not-illustrated imaginary plane).

After exiting the disk 26, the beam of collimated radiation propagates along the path of travel 52 to the imaging lens 17. The imaging lens 17 focuses this beam, and directs it approximately toward the output fiber 13. Depending on the position of the disk 26, this focused beam may or may not strike the end of the output fiber 13, as discussed in more detail later. When the beam reaches a plane 61 that is coincident with the end of the output fiber 13, the beam has a diameter or spot size given by equation (2) below.

$$Spot Size = \frac{4 {μ}^{2} λ f}{π D} , \qquad ( 2 )$$

where λ is wavelength, f is focal length of the lens 17, D is the diameter of the beam at lens 17, and μ² is a beam mode parameter.

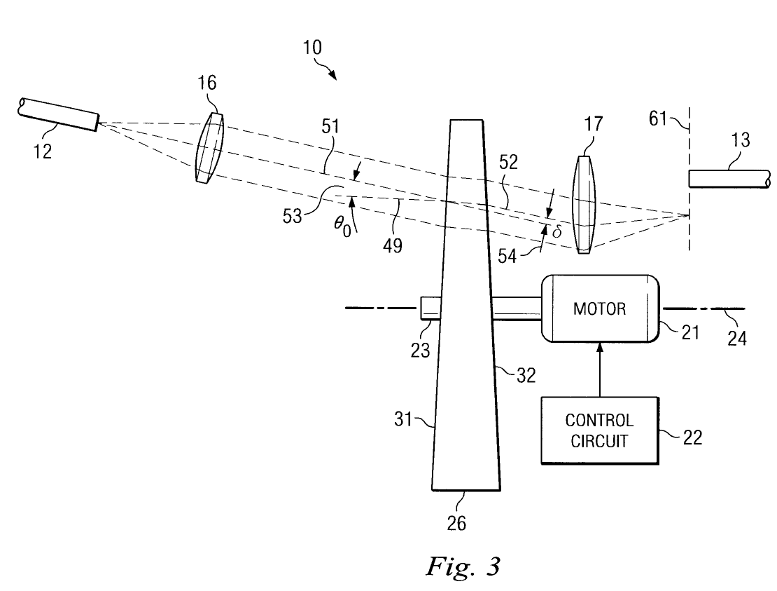

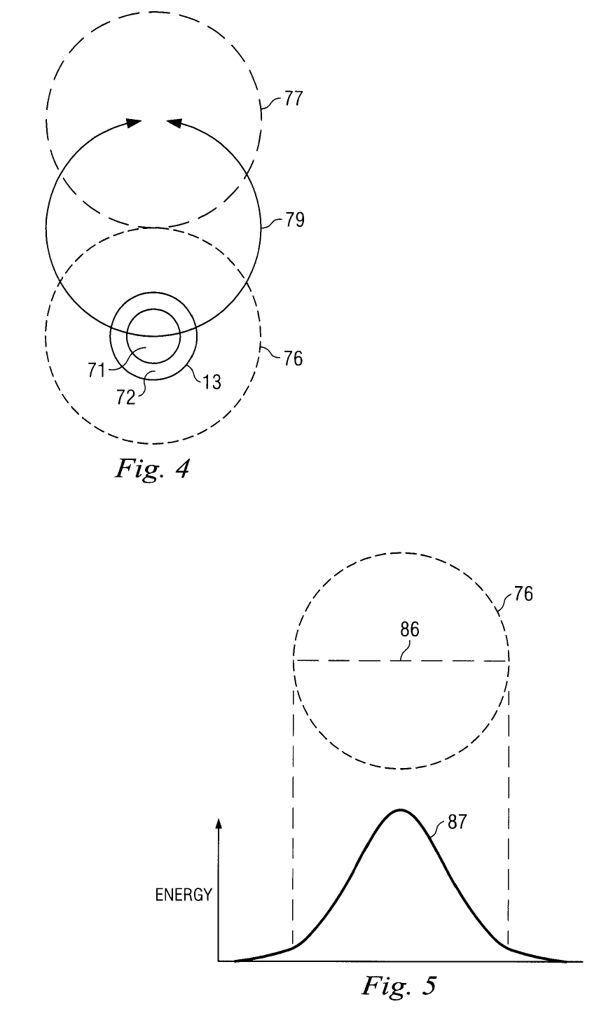

As the disk 26 is rotated in relation to the other structure shown in FIG. 1, there will be a progressive change in the thickness of the portion of the disk that refracts the radiation arriving from the lens 16. In this regard, FIG. 3 is a diagrammatic fragmentary view that is identical to FIG. 1, except that the disk 26 is shown in a different operational position. In particular, in FIG. 3, the disk 26 has been rotated 180° from the position shown in FIG. 1. The portion of the disk 26 influencing radiation from the lens 16 in FIG. 3 is significantly thinner than the portion of the disk influencing radiation in FIG. 1. Consequently, the deviation angle 54 (δ) between the path of travel 51 and the path of travel 52 is smaller in FIG. 3 than in FIG. 1. As a result, the beam of radiation leaving the disk 26 along the path of travel 52 will impinge on the imaging lens 17 at a different location than the beam of radiation in FIG. 1. This in turn shifts the position of the focused beam traveling away from the lens 17 toward the output fiber 13. Thus, for example, it will be noted in FIG. 1 that the focused beam from the lens 17 strikes the end of the fiber 13, whereas in FIG. 3 the focused beam from the lens 17 misses the end of the output fiber 13. This is discussed in more detail below, with reference to FIG. 4.

FIG. 4 is a diagrammatic view in which the plane of the drawing is coincident with the plane 61 (FIG. 1). FIG. 4 shows the end of the output fiber 13, and shows how the beam of radiation moves in relation to the output fiber as the disk 26 rotates. With reference to FIG. 4, the output fiber 13 has a typical configuration, including a cylindrical core 71 that is surrounded by a cylindrical sleeve 72 of cladding material. The broken-line circle 76 represents the location of the beam of radiation when the disk 26 is in the position shown in FIG. 1. The broken-line circle 77 represents the location of the beam of radiation when the disk 26 is in the position shown in FIG. 3. As the disk 26 is rotated, the beam moves along a circular path or travel 76.

FIG. 5 is a diagram showing the energy distribution that is present in the beam of radiation at the plane 61. In particular, the energy in the beam has an approximately Gaussian distribution 87 across a diameter 86 of the beam 76. That is, the energy is strongest at the center of the beam, and drops off progressively in all radial directions from the center of the beam toward the edges of the beam. Thus, with reference to FIGS. 4 and 5, when the beam is in the position shown at 76 in FIG. 4, the central portion of the beam is centered on the core 71 of the output fiber 13, and the output fiber 13 will be receiving a relatively high amount of energy from the beam.

If the disk 26 is then rotated, causing the beam to move away from the position 76 in either direction along the path of travel 79, then the central portion of the beam will move away from the core 71, and the core 71 will receive progressively less energy as the beam moves progressively farther from the position 76 toward the position 77 along the path of travel 79. When the beam is in the position 77, the core 71 of the fiber 13 will be receiving little or no energy from the beam. Thus, the coupling efficiency between the input fiber 12 and the output fiber 13 can be continuously varied by rotating the disk 26.

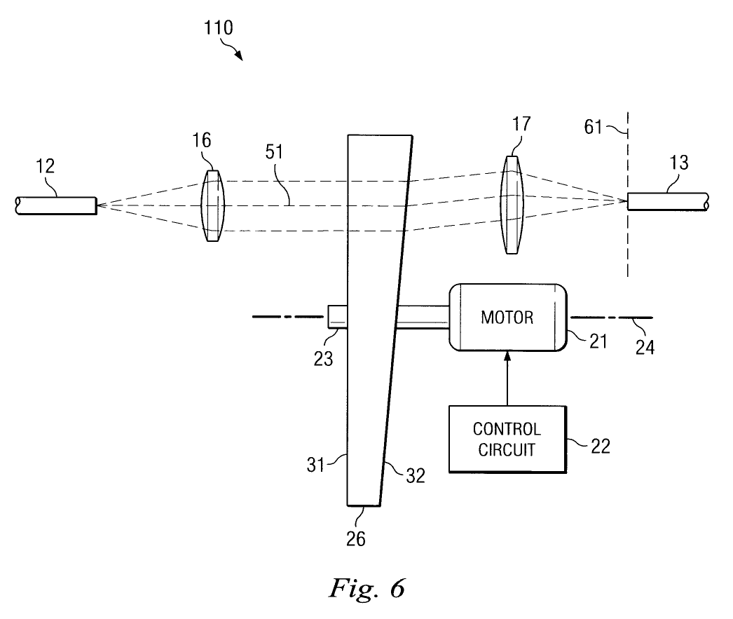

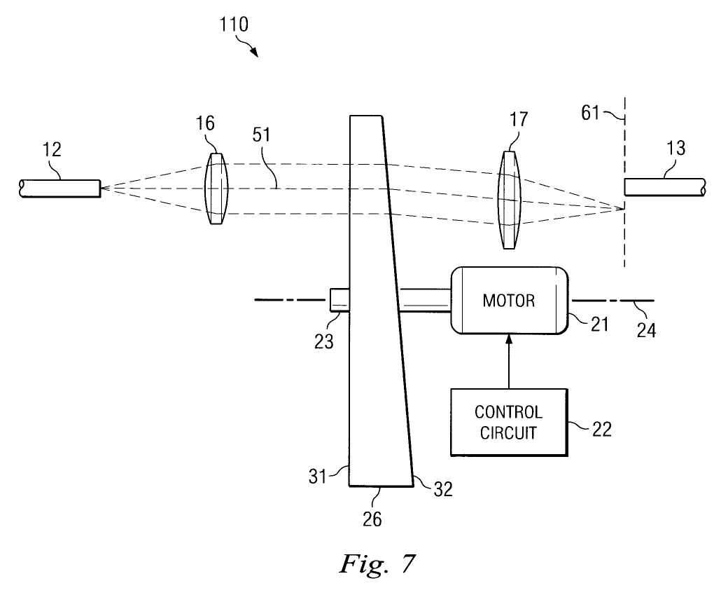

FIG. 6 is diagrammatic fragmentary view of an optical apparatus 110 that is an alternative embodiment of the optical apparatus 10 of FIG. 1, that provides optical power transfer control, and that embodies aspects of the invention. FIG. 7 is a diagrammatic fragmentary view that is identical to FIG. 6, except that the disk 26 is shown in a different operational position. The apparatus 110 of FIGS. 5 and 6 is identical to the apparatus 10 of FIGS. 1-3, except for the differences discussed below.

In the apparatus 110 of FIGS. 6-7, the disk 26 is oriented so that the side surface 31 thereon is perpendicular to the axis of rotation of the shaft 23 of the motor 21. In addition, the fiber 12 and the lens 16 are positioned so that the path of travel 51 is always perpendicular to the side surface 31 of the disk 26, in all rotational positions of the disk. In the apparatus 10 of FIG. 1, the initial angle of incidence 53 (θ₀) will vary. In contrast, in the apparatus 110 of FIGS. 6 and 7, the initial angle of incidence will always be 0°, because the path of travel 51 is always perpendicular to the surface 31. Substituting zero for θ₀ in equation (1) above, equation (1) simplifies down to equation (2) below:

$$\begin{matrix}δ = {sin}^{- 1} ( \frac{{n}_{disk}}{{n}_{air}} * sin \{ {sin}^{- 1} [ \frac{{n}_{air}}{{n}_{disk}} * sin ( 0 ) ] - σ \} ) - \\ {sin}^{- 1} ( \frac{{n}_{disk}}{{n}_{air}} * sin \{ {sin}^{- 1} [ \frac{{n}_{air}}{{n}_{disk}} * sin ( 0 ) ] \} ) \\ = - {sin}^{- 1} ( \frac{{n}_{disk}}{{n}_{air}} * sin \{ σ \} )\end{matrix} \qquad ( 2 )$$

The optical disk 26 in the disclosed embodiments is significantly cheaper than a variable density filter of a type used to carry out optical power transfer in pre-existing systems. Moreover, such a pre-existing filter absorbs energy from the radiation passing through it, whereas the disk 26 does not.

In the disclosed embodiments, the disk 26 is rotated by the rotating shaft 23 of the motor 21, under control of the control circuit 22. However, it would alternatively be possible to omit the motor 21 and the control circuit 22, and to manually adjust the position of the disk 26. As still another alternative, it would be possible to replace the motor 22 with a not-illustrated linear motor, and to replace the disk 26 with a not-illustrated optical strip that is disposed in the converging beam rather than the collimated beam, the strip having a thickness that increases progressively in a direction lengthwise of the strip.

Although a selected embodiment has been illustrated and described in detail, it should be understood that a variety of substitutions and alterations are possible without departing from the spirit and scope of the present invention, as defined by the claims that follow.

What is claimed is:

1. An apparatus comprising:
an optical part that has spaced first and second sections, and that is supported for movement in relation to a first path of travel for radiation, wherein when said part is in a first position, radiation arriving at said part along said first path of travel passes through said first section and is subjected by said first section to a first level of refraction that causes radiation to thereafter propagate along a second path of travel, and wherein when said part is in a second position different from said first position, radiation arriving at said part along said first path of travel passes through said second section and is subjected by said second section to a second level of refraction that is different from said first level of refraction and that causes radiation to thereafter propagate along a third path of travel different from said second path of travel; and
an output part that is supported stationarily with respect to said paths of travel, and that receives a first portion of radiation propagating along said second path of travel and a second portion of radiation propagating along said third path of travel, said first and second portions containing different amounts of optical energy.

2. An apparatus according to claim 1, including structure for selectively effecting movement of said part.

3. An apparatus according to claim 1, wherein said first and second sections of said optical part have the same index of refraction, but have different thicknesses in a direction approximately parallel to said first path of travel.

4. An apparatus according to claim 3, wherein said optical part varies progressively in thickness from said first section thereof to said second section thereof.

5. An apparatus according to claim 4,
wherein said optical part has planar first and surfaces on opposite sides thereof, said first and second surfaces extending at an angle with respect to each other; and
wherein radiation from said first path of travel enters said part through said first surface and exits said part through said second surface.

6. An apparatus according to claim 5, wherein said movement of said optical part is pivotal movement about an axis extending through each of said first and second surfaces.

7. An apparatus according to claim 1, including an optical fiber supported stationarily with respect to said paths of travel and having a core surrounded by cladding, said output part being an end of said core.

8. An apparatus according to claim 7, including a lens supported stationarily with respect to said paths of travel at a location optically between said optical part and said output part, said second and third paths of travel each passing through said lens.

9. An apparatus according to claim 1,
including a lens supported stationarily with respect to said paths of travel at a location spaced from said optical part, and
wherein radiation passing through said lens thereafter propagates along said first path of travel to said optical part.

10. An apparatus according to claim 9,
including an optical fiber supported stationarily with respect to said paths of travel; and
wherein radiation that exits said optical fiber passes through said lens and then travels along said first path of travel to said optical part.

11. A method comprising:
providing an optical part having spaced first and second sections;
supporting said part for movement in relation to a first path of travel for radiation;
moving said part to a first position in which radiation arriving at said part along said first path of travel passes through said first section and is subjected by said first section to a first level of refraction that causes radiation to thereafter propagate along a second path of travel;
moving said part to a second position in which radiation arriving at said part along said first path of travel passes through said second section and is subjected by said second section to a second level of refraction that is different from said first level of refraction and that causes radiation to thereafter propagate along a third path of travel different from said second path of travel; and
receiving at an output part a first portion of radiation propagating along said second path of travel and a second portion of radiation propagating along said third path of travel, said first and second portions containing different amounts of optical energy.

12. A method according to claim 11, including configuring said optical part so that said first and second sections thereof have the same index of refraction, but have different thicknesses in a direction approximately parallel to said first path of travel.

13. A method according to claim 12, wherein said configuring includes configuring said optical part to vary progressively in thickness from said first section thereof to said second section thereof.

14. A method according to claim 13,
including configuring said optical part to have planar first and surfaces on opposite sides thereof, said first and second surfaces extending at an angle with respect to each other; and
wherein radiation from said first path of travel enters said part through said first surface and exits said part through said second surface.

15. A method according to claim 14, wherein said supporting is carried out so that said movement of said optical part is pivotal movement about an axis extending through each of said first and second surfaces.

16. A method according to claim 11, including supporting an optical fiber stationarily with respect to said paths of travel, said optical fiber having a core surrounded by cladding, and said output part being an end of said core.

17. A method according to claim 16, including supporting a lens stationarily with respect to said paths of travel at a location optically between said optical part and said output part, said second and third paths of travel each passing through said lens.

18. A method according to claim 11, including:
supporting a lens stationarily with respect to said paths of travel at a location spaced from said optical part; and
causing radiation that passing through said lens to thereafter propagate along said first path of travel to said optical part.

19. A method according to claim 18, including:
supporting an optical fiber stationarily with respect to said paths of travel; and
causing radiation that exits said optical fiber to pass through said lens and then travel along said first path of travel to said optical part.
